(19) United States
(12) Patent Application Publication
(10) Pub. No.: US 2026/0004702 A1
(43) Pub. Date: Jan. 1, 2026

(54) DISPLAY DEVICE AND CONTROL METHOD OF DISPLAY DEVICE

(71) Applicant: Sharp Display Technology Corporation, Kameyama City (JP)

(72) Inventors: Tatsuhiko SUYAMA, Kameyama City (JP); Hongbing WENG, Kameyama City (JP); Kenji TAKHASHI, Kameyama City (JP); Makoto YOKOYAMA, Kameyama City (JP)

(21) Appl. No.: 19/233,884

(22) Filed: Jun. 10, 2025

(30) Foreign Application Priority Data
Jun. 26, 2024 (JP) 2024-103425

(51) Int. Cl. G09G 3/20; G09G 3/34; G09G 3/36

(52) U.S. Cl. CPC G09G 3/2096; G09G 3/3677; G09G 3/3406; G09G 3/3607; G09G 2300/0804; G09G 2310/0286; G09G 2310/06

(57) ABSTRACT

A display device includes a control circuit. The control circuit transmits a gate control signal to a gate drive circuit so that part of a first period in which a gate signal is supplied to a gate line GL1 overlaps with part of a second period in which a gate signal is supplied to a gate line GL2 and which starts at a time point later than a start time point of the first period. The control circuit transmits a source control signal to a source drive circuit so that each of a first switch and a second switch is turned on once in one cycle of a horizontal synchronization signal. The control circuit transmits the source control signal to the source drive circuit so that one of the first switch and the second switch is turned on in a period in which the first period and the second period overlap each other.

### CROSS-REFERENCE TO RELATED APPLICATIONS

This application claims the benefit of priority to Japanese Patent Application Number 2024-103425 filed on Jun. 26, 2024. The entire contents of the above-identified application are hereby incorporated by reference.

### BACKGROUND

### Technical Field

The disclosure relates to a display device and a control method of a display device.

A drive device of a liquid crystal display disclosed in JP H5-150749 A is configured to perform a doubled-height display operation. In the doubled-height display operation, a display control signal including two basic clock signals is output from a controller during a period in which a latch signal is at a high level. The display control signal is input to a shift register. With this, while the latch signal is at the high level, two rows of row electrodes are selected in the liquid crystal display, and display data for one row is displayed at two rows of pixels in the liquid crystal display. When the number of basic clock signals is three or more during a period in which the latch signal is at the high level, n-fold height display (n is an integer of 3 or more) can be performed.

### SUMMARY

The drive device of the liquid crystal display disclosed in JP H5-150749 A is configured to be capable of integer-fold height display in accordance with the number (integer) of basic clock signals during a period in which a latch signal is at a high level. This makes it possible to reduce the amount of display data. However, for example, there is a case in which image quality is too low in n-fold height display, whereas image quality is excessively higher than necessary in n−1 fold height display (or regular one-fold display). As described above, the drive device of the liquid crystal display disclosed in JP H5-150749 A has a problem that it is difficult to reduce the amount of transmission data per unit time while maintaining image quality.

The disclosure has been conceived to solve the problems described above, and an object thereof is to provide a display device and a control method of a display device, which are capable of reducing the amount of transmission data per unit time while maintaining image quality.

In order to solve the above-mentioned problems, a display device according to a first aspect includes: a plurality of transistors; a plurality of gate lines connected to the plurality of transistors; a plurality of source lines connected to the plurality of transistors; a gate drive circuit configured to supply gate signals to the plurality of gate lines; a source drive circuit configured to supply source signals to the plurality of source lines; and a control circuit configured to transmit a gate control signal to the gate drive circuit and transmit a source control signal to the source drive circuit. The source drive circuit includes an output unit configured to output the source signals, a first switch disposed between the output unit and a first source line group of the plurality of source lines, and a second switch disposed between the output unit and a second source line group of the plurality of source lines. In order that the gate signals are supplied to m gate lines from the gate drive circuit in n cycles of a horizontal synchronization signal, where n is a natural number and m is a natural number greater than n, and a number obtained by dividing m by n is a rational number excluding an integer, the control circuit transmits the gate control signal to the gate drive circuit in such a manner that part of a first period in which the gate signal is supplied to a first gate line of the plurality of gate lines and part of a second period in which the gate signal is supplied to a second gate line adjacent to the first gate line and which starts at a time point later than a start time point of the first period overlap each other. The control circuit transmits the source control signal to the source drive circuit in such a manner that each of the first switch and the second switch is turned on once in one cycle of a horizontal synchronization signal, and transmits the source control signal to the source drive circuit in such a manner that one of the first switch and the second switch is turned on in a period in which the first period and the second period overlap each other.

A control method of a display device according to a second aspect is a control method of a display device including a plurality of transistors, a plurality of gate lines connected to the plurality of transistors, a plurality of source lines connected to the plurality of transistors, a gate drive circuit configured to supply gate signals to the plurality of gate lines, and a source drive circuit configured to supply source signals to the plurality of source lines. The source drive circuit includes an output unit configured to output the source signals, a first switch disposed between the output unit and a first source line group of the plurality of source lines, and a second switch disposed between the output unit and a second source line group of the plurality of source lines. The control method includes, in order that the gate signals are supplied to m gate lines from the gate drive circuit in n cycles of a horizontal synchronization signal, where n is a natural number and m is a natural number greater than n, and a number obtained by dividing m by n is a rational number excluding an integer, causing the gate drive circuit to operate in such a manner that part of a first period in which the gate signal is supplied to a first gate line of the plurality of gate lines and part of a second period in which the gate signal is supplied to a second gate line adjacent to the first gate line and which starts at a time point later than a start time point of the first period overlap each other, causing the source drive circuit to operate in such a manner that each of the first switch and the second switch is turned on once in one cycle of a horizontal synchronization signal, and causing the source drive circuit to operate in such a manner that one of the first switch and the second switch is turned on in a period in which the first period and the second period overlap each other.

According to the above configuration, the amount of transmission data per unit time can be reduced while maintaining image quality.

### BRIEF DESCRIPTION OF DRAWINGS

The disclosure will be described with reference to the accompanying drawings, wherein like numbers reference like elements.

FIG. 1 is a block diagram illustrating a configuration of a display device 100 in a first embodiment.

FIG. 2 is a block diagram illustrating a configuration in a display panel 10.

FIG. 3 is a diagram illustrating part of a configuration of a source drive circuit 3.

FIG. 4 is a timing chart for explaining regular display (one-fold height display) of the source drive circuit 3 according to the first embodiment.

FIG. 5 is a diagram for explaining an example of the regular display (one-fold height display) of the source drive circuit 3.

FIG. 6 is a schematic diagram illustrating a correspondence relationship between transmission data and display on a screen according to the regular display.

FIG. 7 is a timing chart for explaining a doubled-height display operation of the source drive circuit 3 according to the first embodiment.

FIG. 8 is a diagram for explaining an example of doubled-height display of the source drive circuit 3.

FIG. 9 is a schematic diagram illustrating a correspondence relationship between transmission data and display on a screen according to the doubled-height display.

FIG. 10 is a timing chart for explaining a 1.5-fold height display operation of the source drive circuit 3 according to the first embodiment.

FIG. 11 is a diagram for explaining an example of 1.5-fold height display of the source drive circuit 3.

FIG. 12 is a schematic diagram illustrating a correspondence relationship between transmission data and display on a screen according to the 1.5-fold height display.

FIG. 13 is a block diagram illustrating a configuration of a display device 200 according to a second embodiment.

FIG. 14 is a diagram illustrating part of a configuration of a source drive circuit 203 according to the second embodiment.

FIG. 15 is a timing chart for explaining a 1.5-fold height display operation of the source drive circuit 203 according to the second embodiment.

FIG. 16 is a diagram for explaining an example of 1.5-fold height display of the source drive circuit 203 according to the second embodiment.

FIG. 17 is a timing chart for explaining a 1.33-fold height display operation of the source drive circuit 203 according to the second embodiment.

FIG. 18 is a diagram for explaining an example of 1.33-fold height display of the source drive circuit 203 according to the second embodiment.

FIG. 19 is a block diagram illustrating a configuration of a display device 300 according to a third embodiment.

FIG. 20 is a diagram for explaining regions A1 to A5 of a screen according to the third embodiment.

FIG. 21 is an example of a table stored in a setting register 344.

FIG. 22 is a diagram for explaining supply of gate signals according to the third embodiment.

FIG. 23 is a timing chart according to a modified example of the first to third embodiments.

FIG. 24 is a diagram illustrating a display example according to the modified example of the first to third embodiments.

### DESCRIPTION OF EMBODIMENTS

Embodiments of the disclosure will be described below with reference to the drawings. Note that the disclosure is not limited to the following embodiments, and appropriate design changes can be made within a scope that satisfies the configuration of the disclosure. In the description below, the same reference signs are used in common among the different drawings for portions having the same or similar functions, and repeated description thereof will be omitted. Further, the configurations described in the embodiments and the modified examples may be combined or modified as appropriate within a range that does not depart from the gist of the disclosure. For ease of explanation, in the drawings referenced below, the configuration is simplified or schematically illustrated, or some of the components are omitted.

### First Embodiment

### Overall Configuration of Display Device

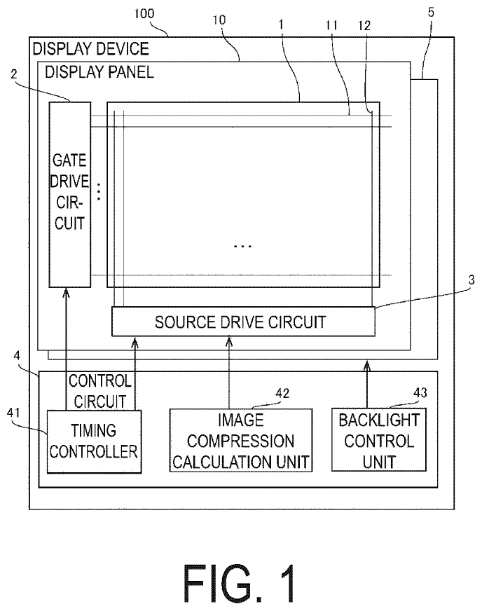

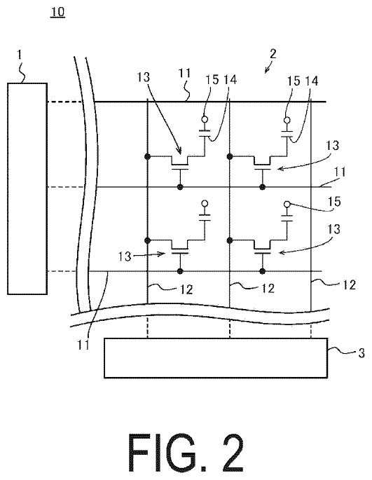

FIG. 1 is a block diagram illustrating a configuration of a display device 100 in a first embodiment. FIG. 2 is a block diagram illustrating a configuration in a display panel 10.

The display device 100 according to the first embodiment is configured as a head-mounted display to be mounted on the head of a person. As illustrated in FIG. 1, the display device 100 is provided with the display panel 10 and a backlight 5. The backlight 5 irradiates the display panel 10 with light, and a user visually recognizes the light transmitted through the display panel 10. In the display device 100, the display panel 10 includes a display unit 1 as a region where an image is displayed, a gate drive circuit 2, a source drive circuit 3, and a control circuit 4. Although FIG. 1 illustrates an example in which the control circuit 4 is disposed outside the display panel 10 (on a substrate different from the display panel 10), the control circuit 4 may be disposed on the display panel 10. The control circuit 4 includes a timing controller 41, an image compression calculation unit 42, and a backlight control unit 43. The timing controller 41, the image compression calculation unit 42, and the backlight control unit 43 may be configured by a common integrated circuit, or may be configured by individual circuits for respective functions.

The timing controller 41 receives timing signals (such as a horizontal synchronization signal, a vertical synchronization signal, and a data enable signal) and an image signal, and generates part of a source control signal (a digital video signal, a source start pulse signal, and a source clock signal) and a gate control signal (such as a gate start pulse signal and a gate clock signal) based on the received signals. The image compression calculation unit 42 generates part of the source control signal (switch control signals SWA and SWB). The timing controller 41 and the image compression calculation unit 42 supply the source control signal to the source drive circuit 3. The timing controller 41 also supplies the gate control signal to the gate drive circuit 2. The backlight control unit 43 turns off the backlight 5 while a pixel electrode 14 (see FIG. 2) is charged, and transmits a signal for turning on the backlight 5 to the backlight 5 after the charging of the pixel electrode 14 is completed.

As illustrated in FIG. 2, a plurality of gate lines 11 connected to the gate drive circuit 2 and a plurality of source lines 12 connected to the source drive circuit 3 are disposed in the display panel 10. The plurality of gate lines 11 and the plurality of source lines 12 are disposed intersecting each other, and a pixel is disposed in each of regions defined by the plurality of gate lines 11 and the plurality of source lines 12. A plurality of the pixels are disposed in a matrix shape in the display panel 10.

Each pixel is provided with a transistor 13 and the pixel electrode 14. A gate electrode of the transistor 13 is connected to the gate line 11. A source electrode of the transistor 13 is connected to the source line 12. A drain electrode of the transistor 13 is connected to the pixel electrode 14.

When the transistor 13 is turned on by a drive signal (gate signal) supplied via the gate line 11, a source signal supplied via the source line 12 is written (charged) to the pixel electrode 14. With this, an electrical field is formed between the pixel electrode 14 and a common electrode 15 disposed to face the pixel electrode 14. The display unit 1 includes a liquid crystal layer (not illustrated). The liquid crystal layer is driven by the electrical field generated between the pixel electrode 14 and the common electrode 15 to display an image on the display unit 1.

### Configuration of Source Drive Circuit 3

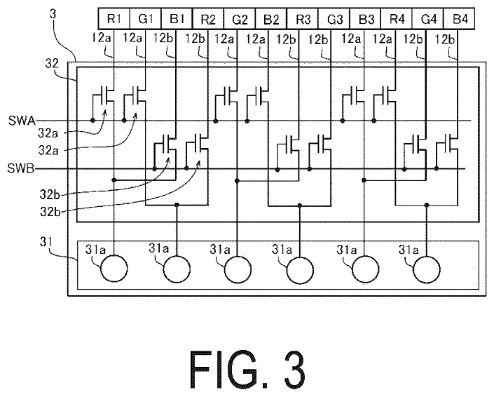

FIG. 3 is a diagram illustrating part of a configuration of the source drive circuit 3. As illustrated in FIG. 3, the source drive circuit 3 includes an output unit 31 configured to output the source signals and a signal distribution unit 32. The source line 12 includes a source line 12a and a source line 12b. For example, as illustrated in FIG. 3, two source lines 12a and two source lines 12b are alternately disposed in the display device 100. A plurality of the source lines 12a form a first source line group. A plurality of the source lines 12b form a second source line group. Based on a digital video signal, a source start pulse signal, and a source clock signal, the output unit 31 outputs a source signal having a different voltage value (gray scale) for each cycle of a horizontal synchronization signal. The output unit 31 includes a plurality (half the number of source lines 12) of output terminals 31a. The plurality of output terminals 31a output source signals having mutually different gray scales.

The signal distribution unit 32 is a demultiplexer configured to distribute the source signals output from the output unit 31 to the first source line group and the second source line group. Specifically, the signal distribution unit 32 includes a switch 32a disposed between the source line 12a and the output terminal 31a, and a switch 32b disposed between the source line 12b and the output terminal 31a. The switch 32a, when the switch control signal SWA is input thereto, is turned on to supply the source signal from the output terminal 31a to the source line 12a. The switch 32b, when the switch control signal SWB is input thereto, is turned on to supply the source signal from the output terminal 31a to the source line 12b. To one output terminal 31a, connected are one source line 12a via the switch 32a and one source line 12b via the switch 32b.

Further, in FIG. 3, a pixel (subpixel) where a red color filter is disposed is denoted by “R”, a pixel (subpixel) where a green color filter is disposed is denoted by “G”, and a pixel (subpixel) where a blue color filter is disposed is denoted by “B”. For example, the source line 12a at the left edge of the paper surface in FIG. 3 is connected to the source electrodes of the transistors 13 in a plurality of “R” pixels (referred to as “R1”) disposed in a column at the left edge of the paper surface.

### Operation of Source Drive Circuit 3

### Regular Display

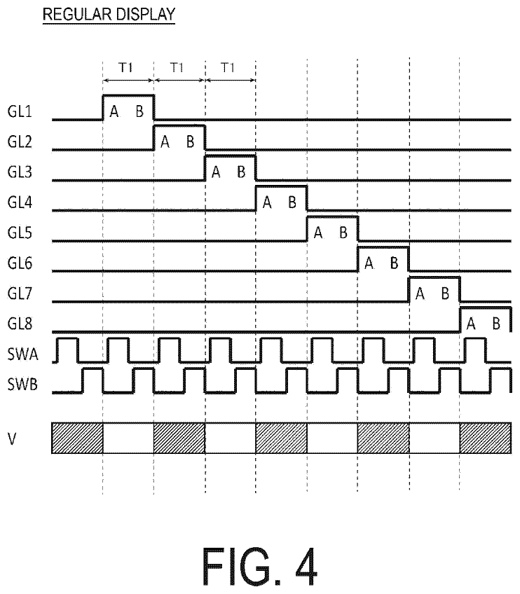

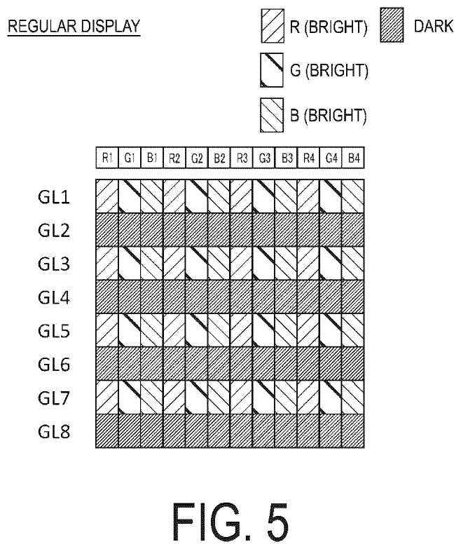

FIG. 4 is a timing chart for explaining regular display (one-fold height display) of the source drive circuit 3 according to the first embodiment. FIG. 5 is a diagram for explaining an example of the regular display (one-fold height display) of the source drive circuit 3. The “regular display” is a method of displaying an image on the display unit 1 by supplying a gate signal to one gate line 11 and supplying source signals to the plurality of source lines 12 in one cycle (a period T1 in FIG. 4) of the horizontal synchronization signal. That is, the regular display is a method in which the gate lines 11 are scanned one by one.

As illustrated in FIG. 4, the voltage of each of the switch control signal SWA and the switch control signal SWB is set to a high level once in one cycle (period T1) of the horizontal synchronization signal. As a result, the switches 32a and 32b of the source drive circuit 3 are turned on once in one cycle (period T1) of the horizontal synchronization signal. Note that “A” in the drawing means a period during which the switch 32a is turned on, and “B” in the drawing means a period during which the switch 32b is turned on.

With the operations of the switches 32a and 32b as described above, in the regular display, a source signal V output in one cycle of the horizontal synchronization signal charges a plurality of (one row of) the pixel electrodes 14 via a plurality of (one row of) the transistors 13 connected to one gate line 11. For example, in the case of the source signal V having such a gray scale that alternately repeats brightness and darkness for each period T1 as illustrated in FIG. 4, the pixels connected to the odd-numbered (“GL1”, “GL3”, . . . ) gate lines 11 become “bright” (a state of transmitting light from the backlight 5), while the pixels connected to the even-numbered (“GL2”, “GL4”, . . . ) gate lines 11 become “dark” (a state of blocking light from the backlight 5), as illustrated in FIG. 5.

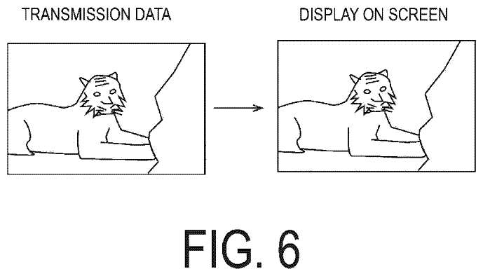

FIG. 6 is a schematic diagram illustrating a correspondence relationship between transmission data and display on a screen according to regular display. The transmission data is a total of source signals (image signals) required to display one screen (one frame). In the regular display, the pixel electrodes 14 of one row are charged for each cycle (period T1) of the horizontal synchronization signal, and therefore the transmission data (source signals) of one row corresponds to one row of display on the screen.

### Doubled-Height Display

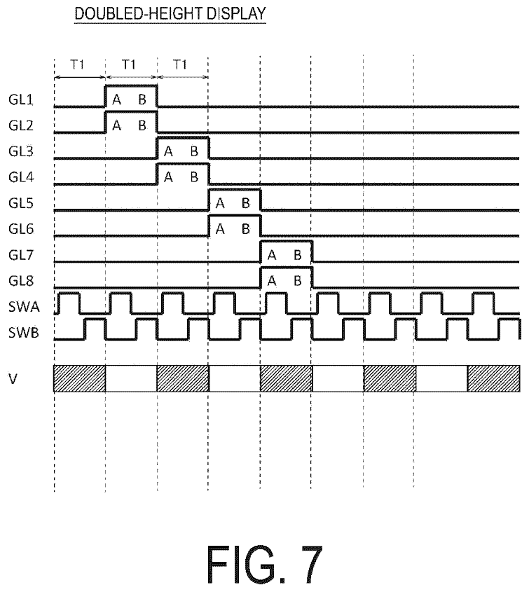

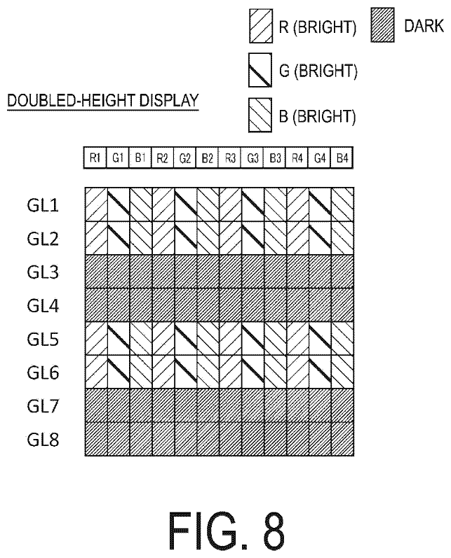

FIG. 7 is a timing chart for explaining a doubled-height display operation of the source drive circuit 3 according to the first embodiment. FIG. 8 is a diagram for explaining an example of doubled-height display of the source drive circuit 3. The “doubled-height display” is a method of displaying an image on the display unit 1 by supplying gate signals to two gate lines 11 and supplying source signals to the plurality of source lines 12 in one cycle (a period T1 in FIG. 7) of the horizontal synchronization signal. That is, the doubled-height display is a method in which the gate lines 11 are scanned by two lines each (twice the number of lines in the regular display).

As illustrated in FIG. 7, similarly to the regular display, the voltage of each of the switch control signal SWA and the switch control signal SWB is set to a high level once in one cycle (period T1) of the horizontal synchronization signal. As a result, the switches 32a and 32b of the source drive circuit 3 are turned on once in one cycle (period T1) of the horizontal synchronization signal.

With the operations of the switches 32a and 32b as described above, in the doubled-height display, source signals output in one cycle of the horizontal synchronization signal charge the plurality of (two rows of) pixel electrodes 14 via the plurality of (two rows of) transistors 13 connected to two gate lines 11. For example, as illustrated in FIG. 7, in the case of the source signal V having such a gray scale that alternately repeats brightness and darkness for each period T1, the pixels connected to the gate lines 11 of “GL1”, “GL2”, “GL5”, “GL6”, and the like become “bright”, while the pixels connected to the gate lines 11 of “GL3”, “GL4”, “GL7”, “GL8”, and the like become “dark”, as illustrated in FIG. 8.

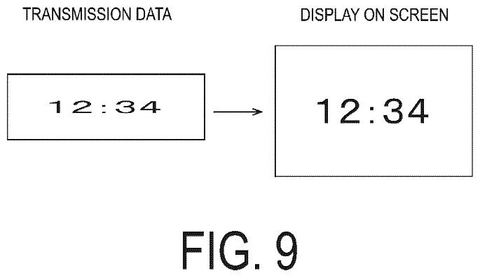

FIG. 9 is a schematic diagram illustrating a correspondence relationship between transmission data and display on a screen according to doubled-height display. In the doubled-height display, the pixel electrodes 14 of two rows are charged for each cycle (period T1) of the horizontal synchronization signal, and therefore the transmission data (source signals) for one row corresponds to two rows of display on the screen. Thus, the amount of transmission data in the doubled-height display is half the amount of transmission data in the regular display. For example, in a case of an image whose required level of image quality is low (in the example of FIG. 9, numerals (indicating information)), the amount of transmission data can be reduced by performing doubled-height display.

### 1.5-Fold Height Display

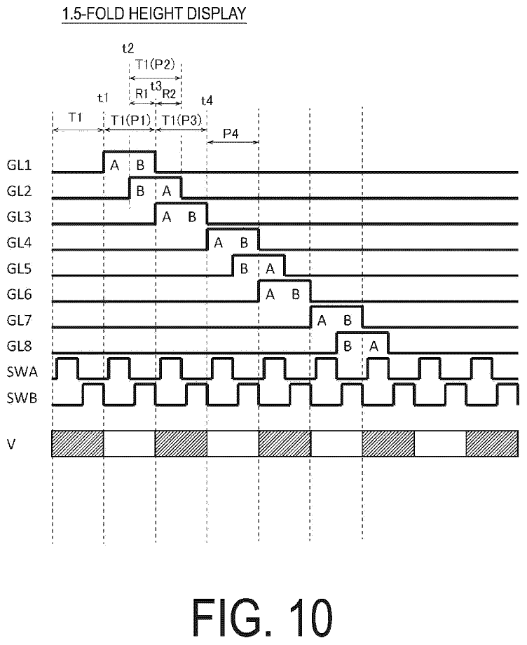

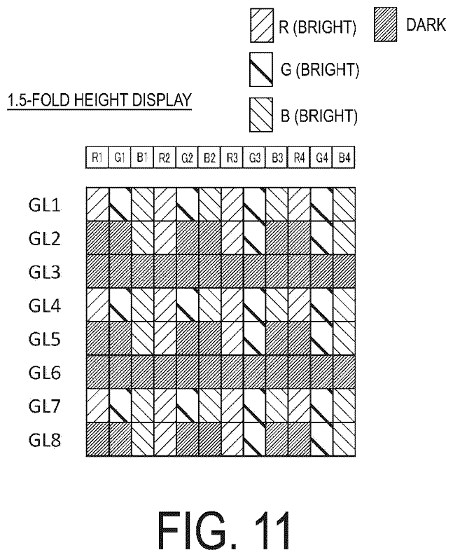

FIG. 10 is a timing chart for explaining a 1.5-fold height display operation of the source drive circuit 3 according to the first embodiment. FIG. 11 is a diagram for explaining an example of 1.5-fold height display of the source drive circuit 3. The “1.5-fold height display” is a method of displaying an image on the display unit 1 by supplying gate signals to three gate lines 11 and supplying source signals to the plurality of source lines 12 in two cycles (two periods T1 in FIG. 10) of the horizontal synchronization signal. That is, the 1.5-fold height display is a method in which the gate lines 11 are scanned by 1.5 lines each (1.5 times the number of lines in the regular display).

As illustrated in FIG. 10, similarly to the regular display, the voltage of each of the switch control signal SWA and the switch control signal SWB is set to a high level once in one cycle (period T1) of the horizontal synchronization signal. As a result, the switches 32a and 32b of the source drive circuit 3 are turned on once in one cycle (period T1) of the horizontal synchronization signal.

With the operations of the switches 32a and 32b as described above, in the 1.5-fold height display, source signals output in two cycles of the horizontal synchronization signal charge the plurality of (three rows of) pixel electrodes 14 via the plurality of (three rows of) transistors 13 connected to three gate lines 11. For example, in the case of the source signal V having such a gray scale that alternately repeats brightness and darkness for each period T1 as illustrated in FIG. 10, among the pixels connected to the gate lines 11 of “GL1” to “GL3”, half thereof become “bright” and the other half thereof become “dark” as illustrated in FIG. 11. Further, among the pixels connected to the gate lines 11 of “GL4” to “GL6”, half thereof become “bright” and the other half thereof become “dark”.

As illustrated in FIG. 10, a period during which a gate signal is supplied to the gate line 11 of “GL1” is a first period P1, a period during which a gate signal is supplied to the gate line 11 of “GL2” is a second period P2, a period during which a gate signal is supplied to the gate line 11 of “GL3” is a third period P3, and a period during which a gate signal is supplied to the gate line 11 of “GL4” is a fourth period P4. In the 1.5-fold height display, the second period P2 starts at a time point t2 later than a start time point t1 of the first period P1. The third period P3 starts at a time point t3 after the start time point t2 of the second period P2. The fourth period P4 starts at a time point t4 after the start time point t3 of the third period P3.

Part of the first period P1 overlaps with part of the second period P2. Part of the second period P2 overlaps with part of the third period P3. However, the third period P3 does not overlap with the fourth period P4. That is, the gate drive circuit 2 supplies the gate signals to the gate lines 11 of “GL1” to “GL3” in such a manner that part of the first period P1 overlaps with part of the second period P2 and the part of the second period P2 overlaps with part of the third period P3 during two cycles of the horizontal synchronization signal.

As illustrated in FIG. 10, the switch control signal SWB is supplied to the switch 32b in a period R1, in which the first period P1 and the second period P2 overlap each other, and the switch 32b is turned on in the period R1. Thus, the source signal in the first period P1 is supplied to the transistors 13 connected with the second source line group (the source line group supplied with the source signal in a state where the switch 32b is turned on) among the plurality of transistors 13 connected to the gate line 11 of “GL2”. Further, the switch control signal SWA is supplied to the switch 32a in a period R2, in which the second period P2 and the third period P3 overlap each other, and the switch 32a is turned on in the period R2. Thus, the source signal in the second period P2 is supplied to the transistors 13 connected with the first source line group (the source line group supplied with the source signal in a state where the switch 32a is turned on) among the plurality of transistors 13 connected to the gate line 11 of “GL2”. As a result, as illustrated in FIG. 11, half of the pixels connected to the gate line 11 of “GL2” become “bright” and the other half thereof become “dark”.

As described above, each of the period R1 and the period R2 is shorter than one cycle of the horizontal synchronization signal, and one of the switch 32a and the switch 32b is set to be ON in the period R1 and the period R2. Thus, the source signal V is supplied to any of the first source line group and the second source line group also in the period R1 and the period R2, and the display device 100 can display an image. As a result, gate signals can be supplied to non-integer 1.5 gate lines 11 per cycle of the horizontal synchronization signal (1.5-fold height display can be performed).

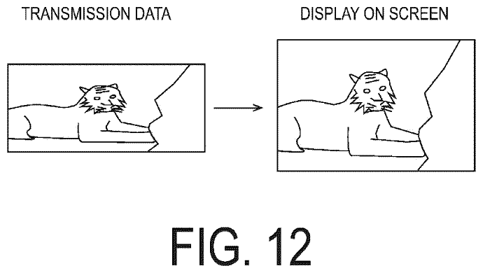

FIG. 12 is a schematic diagram illustrating a correspondence relationship between transmission data and display on a screen according to 1.5-fold height display. In the 1.5-fold height display, the pixel electrodes 14 of three rows are charged every two cycles (two periods T1) of the horizontal synchronization signal, and therefore the transmission data (source signals) for one row corresponds to 1.5 rows of display on the screen. Thus, the amount of transmission data in the 1.5-fold height display is two-thirds the amount of transmission data in regular display. Here, there is a case in which image quality is too low in doubled-height display, whereas image quality is excessively higher than necessary in regular display. In contrast, according to the 1.5-fold height display, since the gate signals can be supplied to 1.5 gate lines 11 per cycle of the horizontal synchronization signal, the amount of transmission data per unit time (per frame) can be reduced as compared with the regular display while maintaining the image quality (maintaining a state where the image quality is not too low and not excessively high).

### Second Embodiment

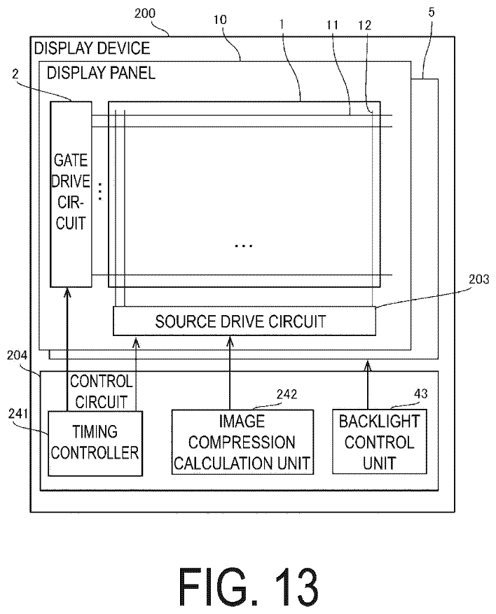

Next, a configuration of a display device 200 according to a second embodiment will be described with reference to FIGS. 13 to 18. In the second embodiment, switches 232a to 232c are provided in a source drive circuit 203, and the switches 232a to 232c are connected to one output unit 231. Note that the same configurations as those of the first embodiment will be denoted by the same reference signs as those of the first embodiment, and descriptions thereof will be omitted.

FIG. 13 is a block diagram illustrating a configuration of the display device 200 according to the second embodiment. As illustrated in FIG. 13, the display device 200 according to the second embodiment includes the source drive circuit 203 and a control circuit 204. The control circuit 204 includes a timing controller 241 and an image compression calculation unit 242. The image compression calculation unit 242 generates a switch control signal SWA for controlling operation of the switch 232a, a switch control signal SWB for controlling operation of the switch 232b, and a switch control signal SWC for controlling operation of the switch 232c. Then, the image compression calculation unit 242 transmits the switch control signals SWA to SWC to the source drive circuit 203.

### Configuration of Source Drive Circuit 203 According to Second Embodiment

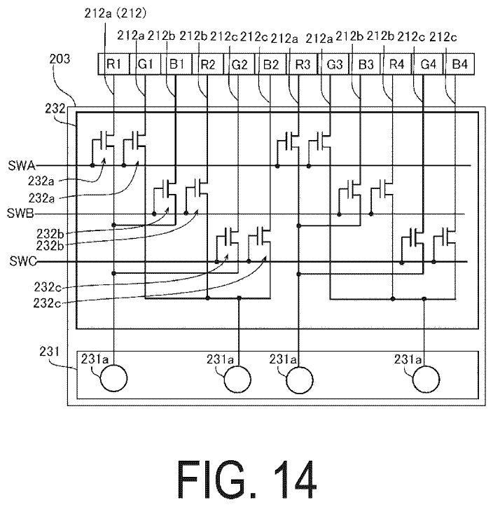

FIG. 14 is a diagram illustrating part of a configuration of the source drive circuit 203 according to the second embodiment. As illustrated in FIG. 14, the source drive circuit 203 includes the output unit 231 configured to output source signals and a signal distribution unit 232. A source line 212 includes a source line 212a, a source line 212b, and a source line 212c. For example, as illustrated in FIG. 14, two source lines 212a, two source lines 212b, and two source lines 212c are repeatedly disposed in this order in the display device 200. A plurality of the source lines 212a form a first source line group. A plurality of the source lines 212b form a second source line group. A plurality of the source lines 212c form a third source line group. Based on a digital video signal, a source start pulse signal, and a source clock signal, the output unit 231 outputs a source signal having a different voltage value (gray scale) for each cycle of a horizontal synchronization signal. The output unit 231 includes a plurality (one-third of the number of source lines 212) of output terminals 231a. The plurality of output terminals 231a output source signals having different gray scales from each other.

The signal distribution unit 232 distributes the source signals output from the output unit 231 to the first source line group, the second source line group, and the third source line group. Specifically, the signal distribution unit 232 includes the switch 232a disposed between the source line 212a and the output terminal 231a, the switch 232b disposed between the source line 212b and the output terminal 231a, and the switch 232c disposed between the source line 212c and the output terminal 231a. The switch 232a, when the switch control signal SWA is input thereto, is turned on to supply the source signal from the output terminal 231a to the source line 212a. The switch 232b, when the switch control signal SWB is input thereto, is turned on to supply the source signal from the output terminal 231a to the source line 212b. The switch 232c, when the switch control signal SWC is input thereto, is turned on to supply the source signal from the output terminal 231a to the source line 212c. Further, to one output terminal 231a, connected are one source line 212a via the switch 232a, one source line 212b via the switch 232b, and one source line 212c via the switch 232c.

### Operation of Source Drive Circuit 203 According to Second Embodiment

### 1.5-Fold Height Display According to Second Embodiment

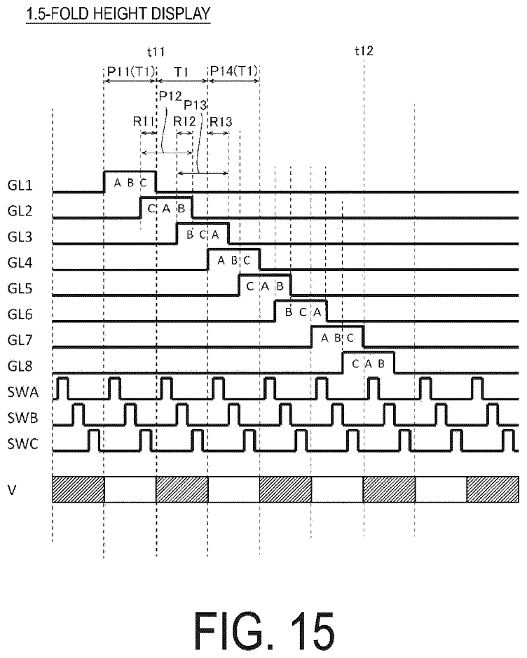

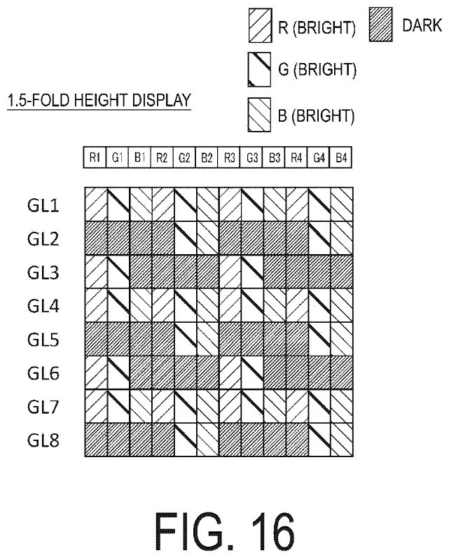

FIG. 15 is a timing chart for explaining a 1.5-fold height display operation of the source drive circuit 203 according to the second embodiment. FIG. 16 is a diagram for explaining an example of 1.5-fold height display of the source drive circuit 203 according to the second embodiment.

As illustrated in FIG. 15, the voltage of each of the switch control signal SWA, the switch control signal SWB, and the switch control signal SWC is set to a high level once in one cycle (period T1) of the horizontal synchronization signal. As a result, the switches 232a to 232c of the source drive circuit 203 are turned on once in one cycle (period T1) of the horizontal synchronization signal.

With the operations of the switches 232a to 232c as described above, in the 1.5-fold height display, source signals output in four cycles of the horizontal synchronization signal (time point t11 to time point t12) charge a plurality of (six rows of) pixel electrodes 14 via a plurality of (six rows of) transistors 13 connected to six gate lines 11. For example, as illustrated in FIG. 15, in the case of a source signal V having such a gray scale that alternately repeats brightness and darkness for each period T1, brightness and darkness are exhibited as illustrated in FIG. 16.

As illustrated in FIG. 15, a period during which a gate signal is supplied to the gate line 11 of “GLn (n is a natural number)” is referred to as an n-th period Pln. In the 1.5-fold height display, an (n+1)-th period P1n+1 starts at a time point later than a start time point of an n-th period Pn. Part of the (n+1)-th period P1n+1 overlaps part of the n-th period Pn. A gate drive circuit 2 supplies the gate signals to a plurality of the gate lines 11 (GLn to GLn+6) during four cycles of the horizontal synchronization signal in such a manner that part of the n-th period P1n overlaps part of an (n+1)-th period Pn+1, part of an (n+1)-th period P1n+1 overlaps part of an (n+2)-th period Pn+2, part of an (n+2)-th period P1n+2 overlaps part of an (n+3)-th period Pn+3, part of an (n+3)-th period P1n+3 overlaps part of an (n+4)-th period Pn+4, part of an (n+4)-th period P1n+4 overlaps part of an (n+5)-th period Pn+5, and part of an (n+5)-th period P1n+5 overlaps part of an (n+6)-th period Pn+6.

As illustrated in FIG. 15, the switch control signal SWC is supplied to the switch 232c in a period R11, in which a first period P11 and a second period P12 overlap each other, and the switch 232c is turned on in the period R11. Thus, the source signal in the first period P11 is supplied to the transistors 13 connected with the third source line group (the source line group supplied with the source signal in a state where the switch 232c is turned on) among the plurality of transistors 13 connected to the gate line 11 of “GL2”. Further, the switch control signal SWB is supplied to the switch 232b in a period R12, in which the second period P12 and a third period P13 overlap each other, and the switch 232b is turned on in the period R12. Further, the switch control signal SWA is supplied to the switch 232a in a period R13, in which the third period P13 and a fourth period P14 overlap each other, and the switch 232a is turned on in the period R13.

As described above, each of the period R11 to period R13 is shorter than one cycle of the horizontal synchronization signal, and one of the switch 232a, the switch 232b, and the switch 232c is set to be ON in the period R11, the period R12, and the period R13. Thus, the source signal V is supplied to any of the first source line group to the third source line group also in the period R11 to the period R13, and the display device 200 can display an image. As a result, gate signals can be supplied to non-integer 1.5 gate lines 11 per cycle of the horizontal synchronization signal (1.5-fold height display can be performed).

### 1.33-Fold Height Display According to Second Embodiment

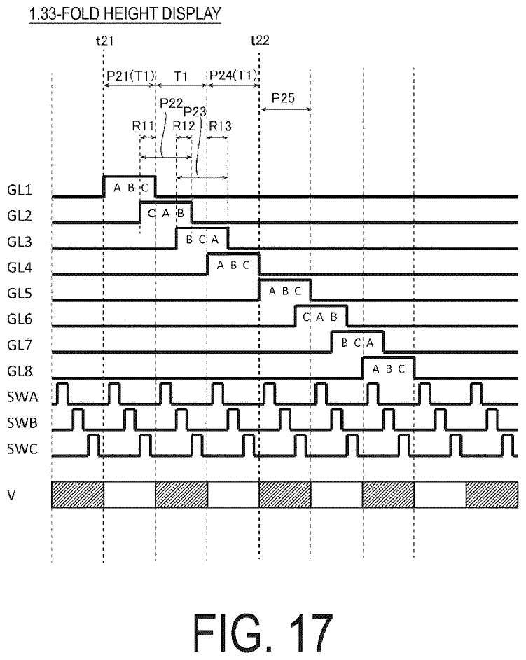

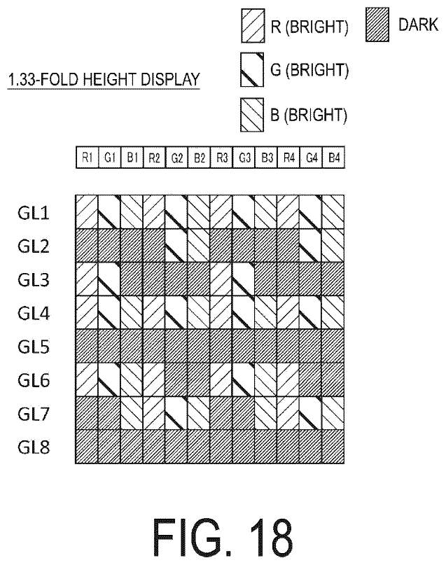

FIG. 17 is a timing chart for explaining a 1.33-fold height display operation of the source drive circuit 203 according to the second embodiment. FIG. 18 is a diagram for explaining 1.33-fold height display of the source drive circuit 203 according to the second embodiment.

As illustrated in FIG. 17, in the 1.33-fold height display, source signals output in three cycles of the horizontal synchronization signal (time point t21 to time point t22) charge the plurality of (four rows of) pixel electrodes 14 via the plurality of (four rows of) transistors 13 connected to four gate lines 11. For example, as illustrated in FIG. 17, in the case of the source signal V having such a gray scale that alternately repeats brightness and darkness for each period T1, brightness and darkness are exhibited as illustrated in FIG. 18.

As illustrated in FIG. 17, in the 1.33-fold height display as well, the (n+1)-th period P1n+1 starts at a time point later than the n-th period Pn. In the 1.33-fold height display, part of a second period P22 overlaps with part of a first period P21. Part of a third period P23 overlaps with part of the second period P22. Part of a fourth period P24 overlaps with part of the third period P23. A fifth period P25 does not overlap with the fourth period P24. Thus, gate signals can be supplied to non-integer 1.33 (four thirds) gate lines 11 per cycle of the horizontal synchronization signal (1.33-fold height display can be performed).

### Third Embodiment

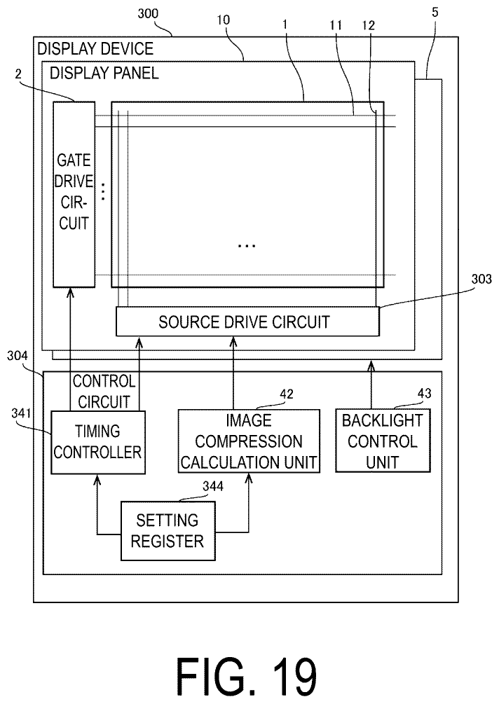

Next, a configuration of a display device 300 according to a third embodiment will be described with reference to FIGS. 19 to 22. In the third embodiment, the display device 300 performs k-fold height display for each region of a screen, where k is a positive rational number. Note that the same configurations as those of the first embodiment will be denoted by the same reference signs as those of the first embodiment, and descriptions thereof will be omitted.

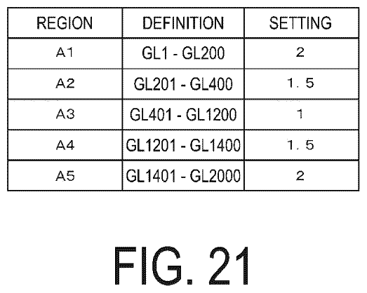

FIG. 19 is a block diagram illustrating a configuration of the display device 300 according to the third embodiment. As illustrated in FIG. 19, the display device 300 according to the third embodiment includes a source drive circuit 303 and a control circuit 304. The control circuit 304 includes a timing controller 341 and a setting register 344 (storage circuit). The setting register 344 is configured such that a table stored therein is rewritten by a setting signal supplied from a host controller (not illustrated) or an external device that supplies an image signal to the display device 300. That is, the table (in which “region”, “definition”, and “setting” are described) stored in the setting register 344 illustrated in FIG. 21 is configured to be updated in accordance with the content of the video (image).

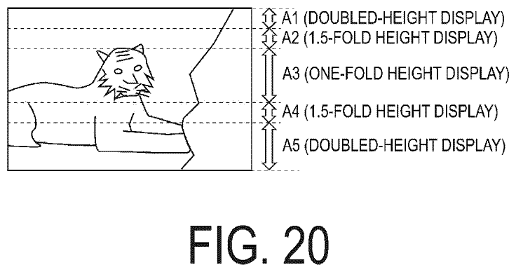

FIG. 20 is a diagram for explaining regions A1 to A5 of a screen according to the third embodiment. FIG. 21 is an example of the table stored in the setting register 344. As illustrated in FIG. 20, the screen is divided into the regions A1 to A5 to be arranged in a vertical direction. For example, when an image of an animal in which an image of the face is arranged at the center as depicted in FIG. 20 is displayed on the display device 300, the image is divided into five regions as depicted in FIG. 21. In this case, the region A1 is a region in which pixels connected to a gate line group from GL1 to GL200 are arranged. The region A2 is a region in which pixels connected to a gate line group from GL201 to GL400 are arranged. The region A3 is a region in which pixels connected to a gate line group from GL401 to GL1200 are arranged. The region A4 is a region in which pixels connected to a gate line group from GL1201 to GL1400 are arranged. The region A5 is a region in which pixels connected to a gate line group from GL1401 to GL2000 are arranged.

The setting register 344 stores setting information (e.g., the table shown in FIG. 21) in which each of the plurality of gate line groups is associated with the number of gate lines 11 supplied with gate signals in one cycle of a horizontal synchronization signal (“setting” in FIG. 21). The timing controller 341 references the setting information (numerical value of “setting”) corresponding to the region to which the gate line 11 transmitting the gate control signal belongs from the setting register 344, and performs fold height display based on the setting information.

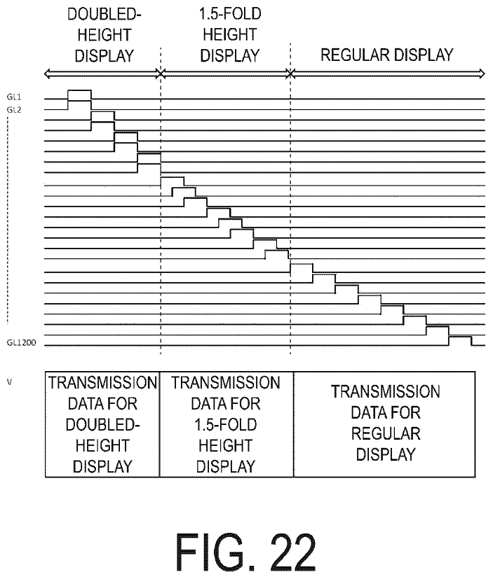

FIG. 22 is a diagram for explaining supply of gate signals according to the third embodiment. As illustrated in FIG. 22, when driving the gate line group in the region A1 (GL1 to GL200), the timing controller 341 supplies a gate control signal to a gate drive circuit 2 to cause the doubled-height display described in the first embodiment to be performed. At this time (when driving the gate line group from GL1 to GL200), source signals are configured by transmission data for the doubled-height display whose data amount is half the data amount of regular display. When driving the gate line group in the region A2 (GL201 to GL400), the timing controller 341 supplies a gate control signal to the gate drive circuit 2 to cause the 1.5-fold height display described in the first or second embodiment to be performed. At this time (when driving the gate line group from GL201 to GL400), source signals are configured by transmission data for the 1.5-fold height display whose data amount is two-thirds the data amount of regular display. When driving the gate line group in the region A3 (GL401 to GL1200), the timing controller 341 supplies a gate control signal to the gate drive circuit 2 to cause the regular display described in the first embodiment to be performed. At this time (when driving the gate line group from GL401 to GL1200), source signals are configured by transmission data for the regular display.

According to the third embodiment, image quality can be changed in accordance with a region (gate line group) for display. Thus, the number of gate lines 11 supplied with the gate signals in one cycle of the horizontal synchronization signal may be increased in a region where high image quality is not required (e.g., the region A1 or A5), while the number of gate lines 11 supplied with the gate signals in one cycle of the horizontal synchronization signal may be decreased in a region where high image quality is required (e.g., the region A3). As a result, even when both a region where high image quality is not required and a region where high image quality is required are present in one screen, the amount of transmission data can be reduced while satisfying the required image quality. Further, a boundary between the high image quality region and the low image quality region can be made less recognizable by the user by arranging the regions A2 between the region A3 with high image quality and the region A1 with low image quality, and arranging the region A4 between the region A3 with high image quality and the region A5 with low image quality; the image quality of the region A2 is between the image quality of the region A3 and the image quality of the region A1, and the image quality of the region A4 is between the image quality of the region A3 and the image quality of the region A5. As a result, even when the image quality is changed in accordance with the region, the user can visually recognize the image without being bothered by a feeling of strangeness.

### Modified Examples

Although embodiments of the disclosure have been described above, the embodiments described above are merely examples for implementing the disclosure. Thus, the disclosure is not limited to the embodiments described above, and can be implemented by appropriately modifying the embodiments described above without departing from the scope of the spirit of the disclosure. Now, modified examples of the above-described embodiments will be described.

(1) The example in which the display device is configured as a liquid crystal display device by providing a liquid crystal layer in the display device is described in the above first to third embodiments, but the disclosure is not limited thereto. For example, the display device may be configured as an organic EL display device, a micro-LED display device, or the like.

(2) The example in which the display device performs 1.33-fold height display and 1.5-fold height display is described in the above first to third embodiments, but the disclosure is not limited thereto. For example, the display device may be configured to perform rational number-fold display other than 1.33-fold height display and 1.5-fold height display. In other words, the display device may be operated in such a manner that gate signals are supplied from the gate drive circuit to m gate lines in n cycles of the horizontal synchronization signal and a number obtained by dividing m by n is a rational number excluding an integer, where n is any natural number and m is any natural number greater than n.

(3) The example in which the switch control signal SWA and the switch control signal SWB are set to a high level in this order in one cycle of the horizontal synchronization signal is described in the above first embodiment, and the example in which the switch control signals SWA to SWC are set to a high level in this order in one cycle of the horizontal synchronization signal is described in the above second embodiment; however, the disclosure is not limited thereto. For example, the order of the switch control signals to be set to the high level may be changed for each cycle of the horizontal synchronization signal. For example, the switch control signals may be generated such that SWA, SWB, and SWC become high levels in this order, and then SWC, SWB, and SWA become high levels in this order.

(4) In the above first to third embodiments, the example in which one source signal is distributed to two source line groups or three source line groups (signal distribution unit: demultiplexer) is described, but the disclosure is not limited thereto. That is, the signal distribution unit of the source drive circuit may be configured to distribute one source signal to four or more source line groups.

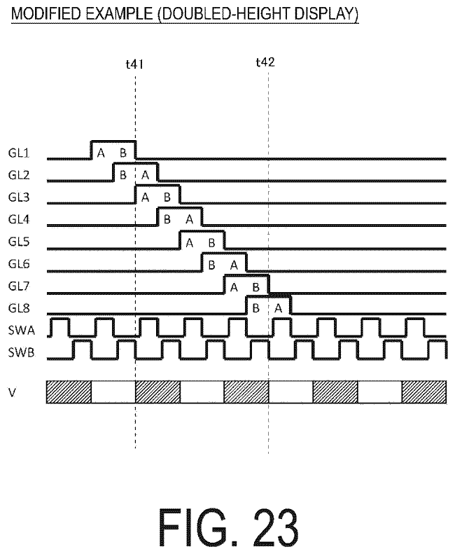

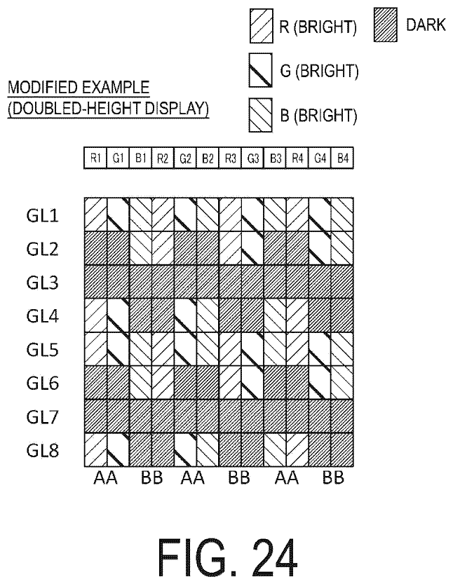

(5) The example in which gate signals are simultaneously supplied to two gate lines in one cycle of the horizontal synchronization signal in order to perform doubled-height display is described in the above first embodiment, but the disclosure is not limited thereto. As in doubled-height display according to a modified example illustrated in FIG. 23, after a period in which a gate signal is supplied to a gate line of GL1, a gate signal may be supplied to a gate line 11 of GLf+1, where f is a natural number. In this case, gate signals are supplied to six gate lines (GL3 to GL7, half of GL2, and half of GL8) in three cycles of the horizontal synchronization signal (between time point t41 and time point t42 in FIG. 23). In the case of the source signal V having such a gray scale that alternately repeats brightness and darkness for each period T1, display is given as illustrated in FIG. 24.

The above-described configuration can also be described as follows.

A display device according to a first configuration includes: a plurality of transistors; a plurality of gate lines connected to the plurality of transistors; a plurality of source lines connected to the plurality of transistors; a gate drive circuit configured to supply gate signals to the plurality of gate lines; a source drive circuit configured to supply source signals to the plurality of source lines; and a control circuit configured to transmit a gate control signal to the gate drive circuit and transmit a source control signal to the source drive circuit. The source drive circuit includes an output unit configured to output the source signals, a first switch disposed between the output unit and a first source line group of the plurality of source lines, and a second switch disposed between the output unit and a second source line group of the plurality of source lines. In order that the gate signals are supplied to m gate lines from the gate drive circuit in n cycles of a horizontal synchronization signal, where n is a natural number and m is a natural number greater than n, and a number obtained by dividing m by n is a rational number excluding an integer, the control circuit transmits the gate control signal to the gate drive circuit in such a manner that part of a first period in which the gate signal is supplied to a first gate line of the plurality of gate lines and part of a second period in which the gate signal is supplied to a second gate line adjacent to the first gate line and which starts at a time point later than a start time point of the first period overlap each other, transmits the source control signal to the source drive circuit in such a manner that each of the first switch and the second switch is turned on once in one cycle of a horizontal synchronization signal, and transmits the source control signal to the source drive circuit in such a manner that one of the first switch and the second switch is turned on in a period in which the first period and the second period overlap each other (the first configuration).

According to the above first configuration, the period in which the first period and the second period that starts at a time point later than the start time point of the first period overlap each other is shorter than one cycle of the horizontal synchronization signal, and one of the first switch and the second switch is turned on in the overlapping period. Thus, the source signal is supplied to one of the first source line group and the second source line group also in the above overlapping period, whereby the display device can display an image. As a result, gate signals can be supplied to non-integer m/n gate lines per cycle of the horizontal synchronization signal (m/n-fold height display can be performed).

Here, assuming that a relation of m/n<k<(m/n)+1 is satisfied, and k is an integer of 2 or more, in the case where gate signals are supplied to integer-k gate lines per cycle of the horizontal synchronization signal (k-fold height display), image quality may be too low, whereas in the case of (k−1)-fold height display (or regular one-fold display), image quality may be excessively higher than necessary. On the other hand, according to the above first configuration, since the gate signals can be supplied to non-integer m/n gate lines per cycle of the horizontal synchronization signal (m/n-fold height display can be performed), the amount of transmission data per unit time (per frame) can be reduced as compared with regular one-fold display while maintaining the image quality (maintaining a state where the image quality is not too low and not excessively high).

In the first configuration, in order that the gate signals are supplied to three gate lines from the gate drive circuit in two cycles of the horizontal synchronization signal, the control circuit may be configured to transmit the gate control signal to the gate drive circuit in such a manner that part of the second period and part of a third period in which the gate signal is supplied to a third gate line adjacent to the second gate line and which starts at a time point later than a start time point of the second period overlap each other (second configuration).

Here, in the case where gate signals are supplied to two gate lines per cycle of the horizontal synchronization signal (doubled-height display), image quality may be too low; on the other hand, in the case of regular one-fold display, image quality may be excessively higher than necessary. In contrast, according to the above second configuration, gate signals are supplied from the gate drive circuit to three gate lines in two cycles of the horizontal synchronization signal. That is, since the gate signals can be supplied to 1.5 gate lines per cycle of the horizontal synchronization signal (1.5-fold height display can be performed), the amount of transmission data per unit time (per frame) can be reduced as compared with regular one-fold display while maintaining the image quality.

In the first or second configuration, the source drive circuit may further include a third switch disposed between the output unit and a third source line group of the plurality of source lines. In order that the gate signals are supplied to m gate lines from the gate drive circuit in n cycles of the horizontal synchronization signal, and a number obtained by dividing m by n is a rational number excluding an integer, the control circuit may be configured to transmit the gate control signal to the gate drive circuit in such a manner that part of the first period and part of the second period overlap each other, transmit the gate control signal to the gate drive circuit in such a manner that part of the second period and a fourth period in which the gate signal is supplied to a fourth gate line adjacent to the second gate line and which starts at a time point later than a start time point of the second period overlap each other, transmit the source control signal to the source drive circuit in such a manner that each of the first switch, the second switch, and the third switch is turned on once in one cycle of the horizontal synchronization signal, and transmit the source control signal to the source drive circuit in such a manner that the third switch is turned on in a period in which the second period and the fourth period overlap each other (third configuration).

According to the above third configuration, the period in which the second period and the fourth period overlap each other is shorter than one cycle of the horizontal synchronization signal, and the third switch is turned on in the overlapping period. Thus, the source signal is supplied to the third source line group also in the above overlapping period, whereby the display device can display an image. As a result, gate signals can be supplied to non-integer m/n gate lines per cycle of the horizontal synchronization signal (m/n-fold height display can be performed).

In the third configuration, in order that the gate signals are supplied to four gate lines from the gate drive circuit in three cycles of the horizontal synchronization signal, the control circuit may be configured to transmit the gate control signal to the gate drive circuit in such a manner that part of the fourth period and part of a fifth period in which the gate signal is supplied to a fifth gate line adjacent to the fourth gate line and which starts at a time point later than a start time point of the fourth period overlap each other, transmit the source control signal to the source drive circuit in such a manner that the first switch is turned on in a period in which the first period overlaps with the second period, and transmit the source control signal to the source drive circuit in such a manner that the second switch is turned on in a period in which the fourth period and the fifth period overlap each other (fourth configuration).

According to the above fourth configuration, gate signals are supplied from the gate drive circuit to four gate lines in three cycles of the horizontal synchronization signal. That is, since gate signals can be supplied to 4/3 (1.33) gate lines per cycle of the horizontal synchronization signal (1.33-fold height display can be performed), the amount of transmission data per unit time (per frame) can be reduced as compared with regular one-fold display while maintaining the image quality.

In any one of the first to fourth configurations, the plurality of gate lines may include a plurality of gate line groups. The display device may further include a storage circuit that stores setting information in which each of the plurality of gate line groups is associated with the number of gate lines supplied with the gate signals in one cycle of the horizontal synchronization signal. The control circuit may be configured to refer to the setting information and change the number of gate lines supplied with the gate signals in one cycle of the horizontal synchronization signal in correspondence with each of the plurality of gate line groups (fifth configuration).

According to the above fifth configuration, image quality can be changed in accordance with a region (gate line group) to be displayed. Thus, the number of gate lines supplied with the gate signals in one cycle of the horizontal synchronization signal may be increased in a region (gate line group) where high image quality is not required, while the number of gate lines supplied with the gate signals in one cycle of the horizontal synchronization signal may be decreased in a region (gate line group) where high image quality is required. As a result, even when both a region where high image quality is not required and a region where high image quality is required are present in one screen, the amount of transmission data can be reduced while satisfying the required image quality.

A control method of a display device according to a sixth configuration is a control method of a display device including a plurality of transistors, a plurality of gate lines connected to the plurality of transistors, a plurality of source lines connected to the plurality of transistors, a gate drive circuit configured to supply gate signals to the plurality of gate lines, and a source drive circuit configured to supply source signals to the plurality of source lines. The source drive circuit includes an output unit configured to output the source signals, a first switch disposed between the output unit and a first source line group of the plurality of source lines, and a second switch disposed between the output unit and a second source line group of the plurality of source lines. The control method includes, in order that the gate signals are supplied to m gate lines from the gate drive circuit in n cycles of a horizontal synchronization signal, where n is a natural number and m is a natural number greater than n, and a number obtained by dividing m by n is a rational number excluding an integer, causing the gate drive circuit to operate in such a manner that part of a first period in which the gate signal is supplied to a first gate line of the plurality of gate lines and part of a second period in which the gate signal is supplied to a second gate line adjacent to the first gate line and which starts at a time point later than a start time point of the first period overlap each other, causing the source drive circuit to operate in such a manner that each of the first switch and the second switch is turned on once in one cycle of a horizontal synchronization signal, and causing the source drive circuit to operate in such a manner that one of the first switch and the second switch is turned on in a period in which the first period and the second period overlap each other (the sixth configuration).

According to the above sixth configuration, it is possible to provide a control method of a display device capable of reducing the amount of transmission data per unit time while maintaining the image quality.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a plurality of transistors;
a plurality of gate lines connected to the plurality of transistors;
a plurality of source lines connected to the plurality of transistors;
a gate drive circuit configured to supply gate signals to the plurality of gate lines;
a source drive circuit configured to supply source signals to the plurality of source lines; and
a control circuit configured to transmit a gate control signal to the gate drive circuit and transmit a source control signal to the source drive circuit,
wherein the source drive circuit includes
an output unit configured to output the source signals,
a first switch disposed between the output unit and a first source line group of the plurality of source lines, and
a second switch disposed between the output unit and a second source line group of the plurality of source lines, and
in order that the gate signals are supplied to m gate lines from the gate drive circuit in n cycles of a horizontal synchronization signal, where n is a natural number and m is a natural number greater than n, and a number obtained by dividing m by n is a rational number excluding an integer, the control circuit
transmits the gate control signal to the gate drive circuit in such a manner that part of a first period in which the gate signal is supplied to a first gate line of the plurality of gate lines and part of a second period in which the gate signal is supplied to a second gate line adjacent to the first gate line and which starts at a time point later than a start time point of the first period overlap each other,
transmits the source control signal to the source drive circuit in such a manner that each of the first switch and the second switch is turned on once in one cycle of a horizontal synchronization signal, and
transmits the source control signal to the source drive circuit in such a manner that one of the first switch and the second switch is turned on in a period in which the first period and the second period overlap each other.

2. The display device according to claim 1,
wherein in order that the gate signals are supplied to three gate lines from the gate drive circuit in two cycles of the horizontal synchronization signal, the control circuit transmits the gate control signal to the gate drive circuit in such a manner that part of the second period and part of a third period in which the gate signal is supplied to a third gate line adjacent to the second gate line and which starts at a time point later than a start time point of the second period overlap each other.

3. The display device according to claim 1,
wherein the source drive circuit further includes a third switch disposed between the output unit and a third source line group of the plurality of source lines, and
in order that the gate signals are supplied to m gate lines from the gate drive circuit in n cycles of the horizontal synchronization signal, and a number obtained by dividing m by n is a rational number excluding an integer, the control circuit
transmits the gate control signal to the gate drive circuit in such a manner that part of the first period and part of the second period overlap each other,
transmits the gate control signal to the gate drive circuit in such a manner that part of the second period and a fourth period in which the gate signal is supplied to a fourth gate line adjacent to the second gate line and which starts at a time point later than a start time point of the second period overlap each other,
transmits the source control signal to the source drive circuit in such a manner that each of the first switch, the second switch, and the third switch is turned on once in one cycle of the horizontal synchronization signal, and
transmits the source control signal to the source drive circuit in such a manner that the third switch is turned on in a period in which the second period and the fourth period overlap each other.

4. The display device according to claim 3,
wherein in order that the gate signals are supplied to four gate lines from the gate drive circuit in three cycles of the horizontal synchronization signal, the control circuit
transmits the gate control signal to the gate drive circuit in such a manner that part of the fourth period and part of a fifth period in which the gate signal is supplied to a fifth gate line adjacent to the fourth gate line and which starts at a time point later than a start time point of the fourth period overlap each other,
transmits the source control signal to the source drive circuit in such a manner that the first switch is turned on in a period in which the first period and the second period overlap each other, and
transmits the source control signal to the source drive circuit in such a manner that the second switch is turned on in a period in which the fourth period and the fifth period overlap each other.

5. The display device according to claim 1,
wherein the plurality of gate lines include a plurality of gate line groups,
the display device further includes a storage circuit that stores setting information in which each of the plurality of gate line groups is associated with the number of gate lines supplied with the gate signals in one cycle of the horizontal synchronization signal, and
the control circuit refers to the setting information and changes the number of gate lines supplied with the gate signals in one cycle of the horizontal synchronization signal in correspondence with each of the plurality of gate line groups.

6. A control method of a display device including a plurality of transistors, a plurality of gate lines connected to the plurality of transistors, a plurality of source lines connected to the plurality of transistors, a gate drive circuit configured to supply gate signals to the plurality of gate lines, and a source drive circuit configured to supply source signals to the plurality of source lines, the source drive circuit including an output unit configured to output the source signals, a first switch disposed between the output unit and a first source line group of the plurality of source lines, and a second switch disposed between the output unit and a second source line group of the plurality of source lines, the method comprising:
in order that the gate signals are supplied to m gate lines from the gate drive circuit in n cycles of a horizontal synchronization signal, where n is a natural number and m is a natural number greater than n, and a number obtained by dividing m by n is a rational number excluding an integer, causing the gate drive circuit to operate in such a manner that part of a first period in which the gate signal is supplied to a first gate line of the plurality of gate lines and part of a second period in which the gate signal is supplied to a second gate line adjacent to the first gate line and which starts at a time point later than a start time point of the first period overlap each other;
causing the source drive circuit to operate in such a manner that each of the first switch and the second switch is turned on once in one cycle of a horizontal synchronization signal, and
causing the source drive circuit to operate in such a manner that one of the first switch and the second switch is turned on in a period in which the first period and the second period overlap each other.
